(19) United States
(12) Patent Application Publication
(10) Pub. No.: US 2017/0151682 A1
(43) Pub. Date: Jun. 1, 2017

(54) KNIFE STRUCTURE CAPABLE OF SAFELY REPLACING BLADE

(71) Applicant: KANTAS PRODUCTS CO., LTD., Taipei City (TW)

(72) Inventor: Yang-Fu CHENG, Taipei City (TW)

(73) Assignee: KANTAS PRODUCTS CO., LTD., Taipei City (TW)

(21) Appl. No.: 15/000,153

(22) Filed: Jan. 19, 2016

(30) Foreign Application Priority Data
Nov. 30, 2015 (TW) 104219220

(51) Int. Cl. B26B 5/00

(52) U.S. Cl. CPC B26B 5/00

(57) ABSTRACT

This application is to provide a knife structure which comprises a handle, a locating main body having an engagement part extended from an end thereof, configured to engage with two engagement slots formed on a blade and having other end connected to the handle, and a poke element pivotally connected to the handle adjacent to the other end of the locating main body and having a push part disposed at an end thereof and a poke part disposed at other end thereof. Under a condition that the poke part is poked to rotate, the push part is inserted into a sunken portion of the locating main body to force the other end of the blade to bend, deform and escape from a state of being engaged, so as to enable the blade to be pulled out in a direction away from the handle.

### FIELD OF THE INVENTION

The present disclosure generally relates to a knife structure, more particularly to a knife structure capable of safely replacing a blade.

### BACKGROUND OF THE INVENTION

In recent year, as technologies are greatly progressed and people's life qualities are improved, during purchasing most people start to consider whether a novel product has all of excellent quality, reasonable price, accessibility, endurability and safety. In response to the change in the market trend, most manufacturers continuously make in an effort to develop new and improved products to meet most customers' demand. Taking a knife product as example, the knife manufacturers usually design knifes having different types of blade for different demands and conditions, to enable a user to operate the knife in a force-saving and precise way.

According to structure, the blades can be classified into plain edge and serrated edge types. The plain edge type of blade has a smooth cutting edge and can be used to precisely perform cutting. The serrated edge type of blade has a serrated cutting edge to make larger contact area during cutting, so that the user can operate in a force-saving way. Both types of blades have different advantages and drawbacks, so some manufacturers integrate features of two types of blade to develop a part serrated edge type of blade. As its name implies, the part serrated edge type of blade has a part designed as the plain edge and remaining part designed as the serrated edge, and the manufacturer can adjust the locations and ratios of the plain edge part and the serrated edge part. The part serrated edge type of blade can be viewed as a combination of the plain edge part and the serrated edge part, and each of the plain edge part and the serrated edge part has a length shorter than a full length of the blade, so it is not easy to use such blade as the full plain edge type or the full serrated edge of blade in some conditions.

Different types of blades have different advantages and drawbacks, and the knife with the part serrated edge type of blade cannot replace the knife with full plain edge type or full serrated edge type of blade, so the user must carry multiple knifes for different purposes in case of accident need, but it causes an increased purchase cost, a heavier carry load and an inconvenient maintenance operation. In addition, when the blade of the knife is battered after long-term use, the user can not just replace the blade and must buy a new knife. Therefore, what is need is to provide a knife with a replaceable blade to solve the problems of conventional knife.

During research, the inventor found a structural concept of medical scalpel with a replaceable blade. Please refer to FIG. 1 which shows a schematic view of a scalpel. A scalpel 1 includes a blade 11 and a handle 12, and the blade 11 has an engagement slot 110 cut therethrough along a longitudinal direction, and the handle 12 has an engagement part 121 protruded and extended at a front end thereof, and the engagement part 121 has a groove 122 formed on a peripheral edge of a front section thereof. While assembling the scalpel 1, the user must align the engagement slot 110 of the blade 11 with the groove 122, and push the blade 11 towards the handle 12 to make an end portion 111 of the blade 11 abut with a rear section of the engagement part 121, so that the end portion 111 of the blade 11 is bent and deformed to enable an inner side of the front section of the engagement slot 110 to be engaged into the groove 122. After the end portion 111 of the blade 11 crosses the rear section of the engagement part 121, the engagement slot 110 is completely engaged with the engagement part 121, so that the blade 11 is fixed with the handle 12.

When unloading the blade 11, the user must hold the front end 112 of the blade 11 by one hand and pull the end portion 111 of the blade 11 by other hand to bend the blade 11, to lift the end portion 111 to be as high as the rear section of the engagement part 121, so that the front end 112 of the blade 11 can be moved to unload the blade 11. The user is hard to unload the blade 11 without using dual hands, so it is inconvenient to use the scalpel 1 having the replaceable blade 11. In addition, the blade 11 is very keen and has a small area to be held, so obviously it is not safe for user to replace the blade 11 by above-mentioned manner, and it is also not easy and intuitional for the user to quickly replace the blade 11.

Therefore, a primary objective of the present invention is to apply the concept about the replaceable structure of the scalpel to the general knife product, and also design an easy-replaceable structure to enable the user to replace the blade by single hand in an easy, safe and quick manner, so as to solve the inconvenient problem that the user must carry multiple conventional knifes in prior art.

### SUMMARY OF THE INVENTION

In order to solve the heavy carrying load problem caused by that the user must carry multiple knife products having different types of blade upon different demands, the inventor designs and develops a knife structure capable of safely replacing a blade according to multiple tests and long-term practical experience in developing knife product.

An objective of the present invention is to provide a knife structure for safely replacing blade. The knife is applied to a blade which has a tip formed at an end thereof and a first engagement slot and a second engagement slot sequentially formed on portions adjacent to other end thereof in a longitudinal direction and cut therethrough. The first and second engagement slots are jointed and communicated with each other. The first engagement slot is closer to the tip and has a slot width smaller than that of the second engagement slot. The knife structure includes a handle, a locating main body and a poke element. The locating main body has an engagement part extended from an end thereof and configured to engage and fix the blade, and has other end connected to the handle. A width of the locating main body is larger than a slot width of the first engagement slot but smaller than a slot width of the second engagement slot. The engagement part has a groove disposed on a peripheral edge of a front section thereof, and the locating main body has a sunken portion disposed on a portion thereof adjacent to a rear section of the engagement part. Under a condition that the front section of the engagement part is inserted into the second engagement slot by a predetermined angle to make the groove correspond to a location where the first engagement slot and the second engagement slot are jointed with each other, the other end of the blade is tightly abutted against the rear section of the engagement part while the blade is pushed towards the handle, so as to bend and deform the rear section of the engagement part to enable the front section of the engagement part to be engaged into the first engagement slot through the groove. After the other end of the blade crosses the rear section of the engagement part, the first engagement slot and the second engagement slot are engaged and located on the engagement part to enable the other end of the blade to be located in the sunken portion and release deformation of the blade, so as to engage the blade on the locating main body firmly. The poke element is pivotally connected to a location in the handle and adjacent to the other end of the locating main body through a pivot pin, and has a push part disposed at an end thereof and a poke part disposed at other end thereof. Under a condition that the poke part is poked to rotate, the push part can be inserted into the sunken portion to abut with the other end of the blade and force the other end of the blade to bend and deform, to make the second engagement slot escape from a state of being engaged and located on the rear section of the engagement part, so as to enable the blade to be pulled out in a direction away from the handle. Therefore, the user just needs to carry single knife and replace different types of blade upon different demands, so the knife structure of the present invention can greatly improve the carrying convenience of the knife.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a schematic view of a conventional scalpel.

FIG. 2 is a schematic view a preferred embodiment of a knife structure of the present invention.

FIG. 3A is a schematic view of a usage status of the knife structure of the present invention.

FIG. 3B is a schematic view of other usage status of the knife structure of the present invention.

FIG. 4 is a schematic view of other preferred embodiment of the knife structure of the present invention.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’. ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

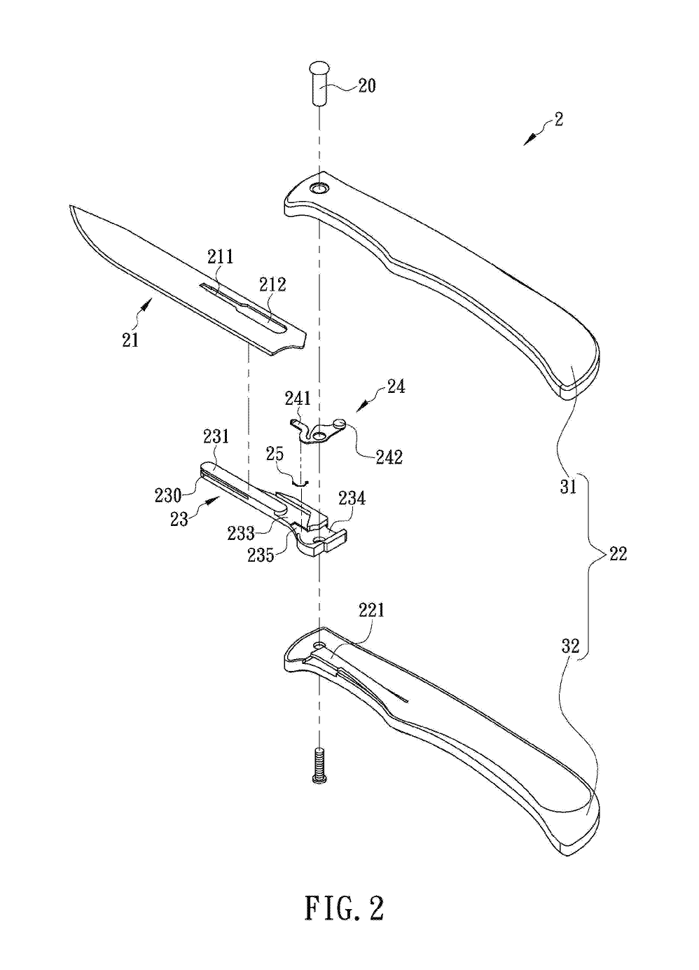

The present invention discloses a knife structure capable of safely replacing a blade. Please refer to FIG. 2 which shows a first preferred embodiment of the present invention. The knife structure is applied to a blade 21. The blade 21 has a tip formed at an end thereof, and a first engagement slot 211 and a second engagement slot 212 sequentially formed at a part adjacent to other end thereof along a longitudinal direction and cut therethrough. The first and second engagement slots 211 and 212 are jointed and communicated with each other, and the first engagement slot 211 is closer to the tip and has a slot width smaller than that of the second engagement slot 212.

The knife structure 2 includes a handle 22, a locating main body 23 and a poking element 24. The locating main body 23 has an end extended to form an engagement part 231 for engaging and fixing with the blade 21, and other end connected to the handle 22. A width of the engagement part 231 is larger than a slot width of the first engagement slot 211, but smaller than a slot width of the second engagement slot 212. The engagement part 231 has a groove 230 formed on a peripheral edge of a front section thereof, and the locating main body 23 has a sunken portion 233 formed at a location adjacent to a rear section of the engagement part 231 and having a structure matching with the other end of the blade 21.

While assembling the blade 21, the user first inserts the front section of the engagement part 231 into the second engagement slot 212 by a predetermined angle (that is, there is an inclined angle formed between the engagement part 231 and the blade 21), to make the groove 230 correspond to a location where the first engagement slot 211 and the second engagement slot 212 are jointed with each other. Next, the user hold and push the blade 21 towards the handle 22 to make other end of the blade 21 tightly abut against the rear section of the engagement part 231, so as to further bend and deform the rear section of the engagement part 231 to enable the front section of the engagement part 231 to be engaged with the first engagement slot 211 through the groove 230. After the other end of the blade 21 crosses the rear section of the engagement part 231, the first engagement slot 211 and the second engagement slot 212 are engaged and located on the engagement part 231, and the other end of the blade can be located in the sunken portion 233 and, in the meantime, the other end of the blade 21 is not abutted with the rear section of the engagement part 231, so that the deformation status of the other end of the blade 21 is released and the blade 21 can be engaged in the locating main body 23 firmly.

The poking element 24 has a part adjacent to a middle section thereof and pivotally connected to, by a pivot pin 20, a part of the handle 22 adjacent to the other end of the locating main body 23. The poking element 24 has a push part 241 disposed at an end thereof and a poke part 242 disposed at other end thereof. In this embodiment, the locating main body 23 has an assembly groove 234 disposed at the other end thereof and adjacent to the sunken portion 233, and the pivot pin 20 can be inserted through the assembly groove 234 to locate the poke element 24 in the assembly groove 234. The push part 241 is movably disposed at a location adjacent to the other end of the blade 21 and the sunken portion 233, so that the push part 241 can be moved close to or away from the sunken portion 233 while the poke element 24 is rotated about the pivot pin 20. However, in other embodiment of the present invention, the poke element 24 can also be pivotally connected to other element inside the handle 22, so long as the push part 241 can be adjacent to the sunken portion 233.

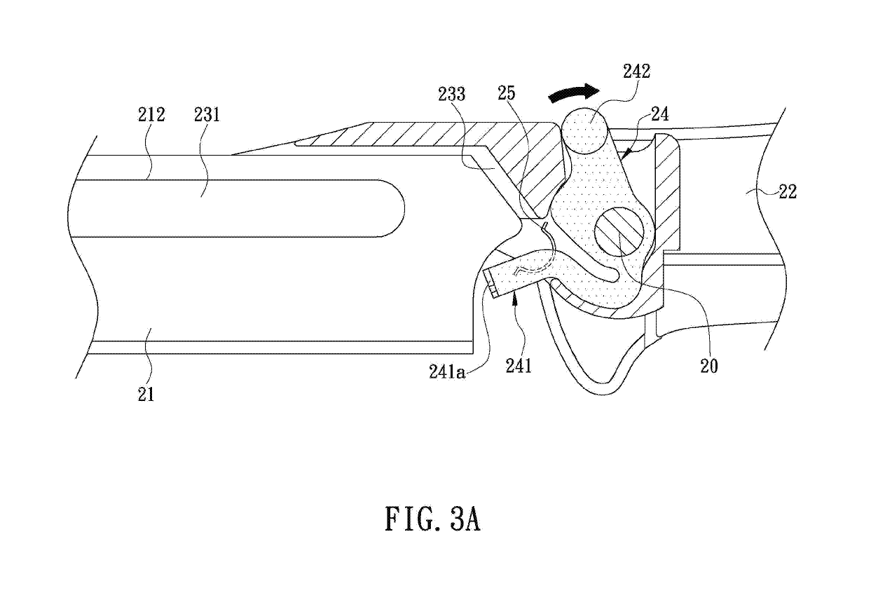

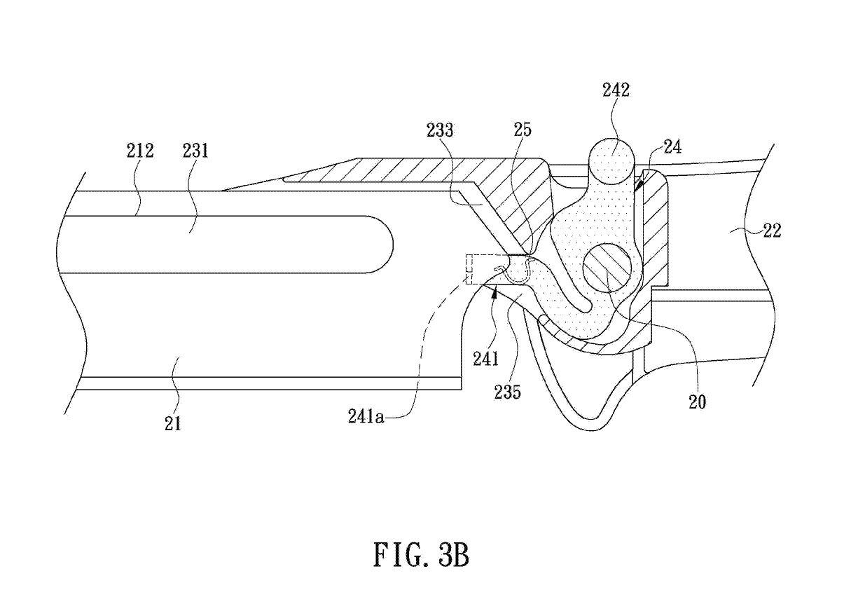

The way of replacing the blade 21 of the knife structure 2 is described below. Please refer to FIGS. 2, 3A and 3B. When the user pokes the poke part 242 to rotate the poke element 24, the push part 241 is inserted into the sunken portion 233 to abut with the other end of the blade 21, so that the other end of the blade 21 is bended and deformed in a direction away from the sunken portion 233 subjected to an applied force, and the second engagement slot 212 is further escaped from a status of being engaged and located in the rear section of the engagement part 231. At this time, the user can easily pull the blade 21 away from the handle 22 to make the blade 21 escape from the locating main body 23.

By means of the design of the knife structure 2 of the present invention, the user can select and buy a variety of types or patterns of blades 21 (such as the plain edge type, the part serrated edge type, the combo edge type, full serrated edge type and so on) upon demand, and engage the corresponding blade 21 on the locating main body 23 in different case. Therefore, the user does not need to buy various types of knife, and for the user, it is advantageous that the purchase cost can be reduced, convenience of carrying the knife can be improved because of just carrying a knife and the replaceable blades 21, and the endurability of the knife can be improved because of keeping the handy handle 22 and just replacing the battered blade 21. In addition, the knife manufacturers do not need to produce individual knife products for various types of blades 21, so it is advantageous for the knife manufacturers to control production and warehouse costs more easily according to the knife structure of the present invention.

Please refer back to FIGS. 2 and 3A. In this embodiment, the sunken portion 233 is provided with a groove 235 disposed correspondingly to a side of the push part 241. The groove 235 has a structure matching with that of the push part 241 and is communicated with the assembly groove 234, so that the push part 241 can be inserted into the sunken portion 233 through the groove 235. The push part 241 is sheet-shaped and has a protruding part 241a disposed at an end thereof. When the push part 241 is inserted into the groove 235, the protruding part 241a can be exposed to the sunken portion 233 through the groove 235, to push the other end of the blade 21. The protruding part 241a can be formed by bending an end of the push part 241, or the protruding part 241a can be a protruding point or a block. For example, the push part 241 can have a thickness gradually decreased from the end thereof to other end thereof, so as to form the protruding part 241a.

In other preferred embodiment of the present invention, the push part 241 can be inserted into the sunken portion 233 by other manner. For example, the blade 21 has an inclined surface disposed on the other end thereof and facing a side of the sunken portion 233, to enable the push part 241 to push the blade 21 along the inclined surface. In addition, the poke element 24 is not limited to be disposed in the assembly groove 234. The embodiment of the present invention is just required that the poke element 24 is located at a location adjacent to the other end of the blade 21 and a gap is formed between the sunken portion 233 and the other end of the blade 21, so as to enable the push part 241 to be inserted into the sunken portion 233.

Please refer back to FIGS. 2, 3A and 3B. In order to improve the safety in using the knife, the knife structure 2 further includes a recovering spring 25 which is disposed in the groove 235 of the locating main body 23 and has two corresponding ends connected to the poke element 24 and the locating main body 23 respectively. Under a condition that the poke part 242 is not poked, the push part 241 is kept in the location away from the sunken portion 233 subject to the resilient recovering force of the recovering spring 25, so as to prevent the user from poking the poke part 242 accidently to cause instability of the blade 21. Alternatively, in other preferred embodiment of the present invention, the two ends of the recovering spring 25 can be connected to the poke element 24 and the handle 22, respectively.

In the first preferred embodiment of the present invention, the knife structure 2 is a folding-knife structure, that is, the other end of the locating main body 23 is pivotally connected in the handle 22 through the pivot pin 20, and the handle 22 is formed by an upper casing 31 and a lower casing 32 which define a receiving space inside the handle 22. Therefore, the user can receive the locating main body 23 and the blade 21 into the receiving space, or rotate the locating main body 23 and the blade 21 out of the handle 22.

The handle 22 has an elastic stop plate 221 disposed on an inside wall thereof (that is, the side of the lower casing 32 facing the receiving space). The elastic stop plate 221 has a fix end fastened at a location in the handle 22 and away from the locating main body 23, and a free end movably extended into the receiving space and adjacent to the other end of the locating main body 23. Under a condition that the locating main body 23 is completely rotated out of the handle 22, the free end of the elastic stop plate 221 is abutted against the other end of the locating main body 23. Under a condition that the free end of the elastic stop plate 221 is pressed towards the inside wall of the handle 22, the locating main body 23 can be rotated towards the receiving space to be receive into the receiving space.

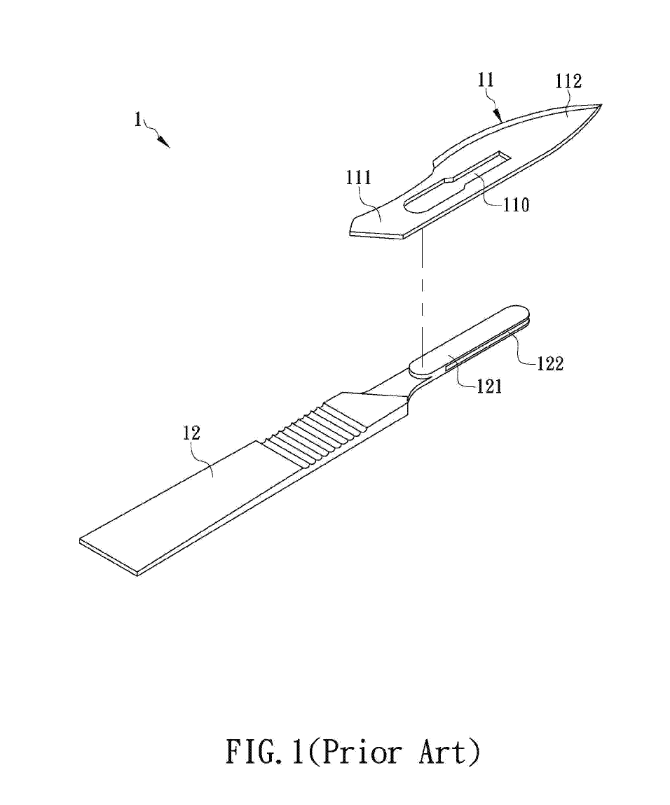

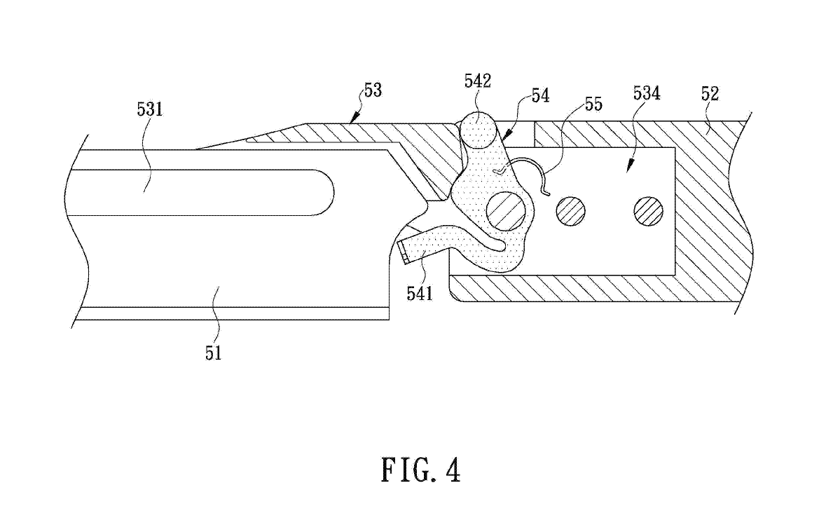

Alternatively, the knife structure 2 can be design as a straight knife in which the blade cannot be rotated, that is, the other end of the locating main body 23 is fastened in the handle 22, or formed with the handle 22 integrally (such as the handle 12 and the engagement part 121 shown in FIG. 1), so that the blade 21 cannot be rotated for receiving. Please refer to FIG. 4 which shows a schematic view of a straight knife. The straight knife includes a blade 51, a handle 52, a locating main body 53, a poke element 54 and a recovering spring 55. The locating main body 53 can be fastened on an end of the handle 52, or engaged with the blade 51 through an engagement part 531. The poke element 54 is located in the locating main body 53 or in a assembly groove 534 inside the handle 52, and has a push part 541 and a poke part 542 extended thereon, so that the user can operate the push part 541 to push the blade 51 to replace the blade 51 easily by the way shown in FIGS. 2 through 3B.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A knife structure, applied to a blade which has a tip formed at an end thereof and a first engagement slot and a second engagement slot sequentially formed on portions adjacent to other end thereof in a longitudinal direction and cut therethrough, and the first and second engagement slots jointed and communicated with each other, the first engagement slot being closer to the tip and having a slot width smaller than that of the second engagement slot, and the knife structure comprising:
a handle;
a locating main body, having an engagement part extended from an end thereof and configured to engage and fix the blade, and having other end connected to the handle, and having a width larger than a slot width of the first engagement slot but smaller than a slot width of the second engagement slot, wherein the engagement part has a groove disposed on a peripheral edge of a front section thereof, and the locating main body has a sunken portion disposed on a portion thereof adjacent to a rear section of the engagement part, and wherein under a condition that the front section of the engagement part is inserted into the second engagement slot by a predetermined angle to make the groove correspond to a location where the first engagement slot and the second engagement slot are jointed with each other, the other end of the blade is tightly abutted against the rear section of the engagement part while the blade is pushed towards the handle, so as to bend and deform the rear section of the engagement part to enable the front section of the engagement part to be engaged into the first engagement slot through the groove, and wherein after the other end of the blade crosses the rear section of the engagement part, the first engagement slot and the second engagement slot are engaged and located on the engagement part to enable the other end of the blade to be located in the sunken portion and release deformation of the blade, so as to engage the blade on the locating main body firmly; and
a poke element, pivotally connected to a location in the handle and adjacent to the other end of the locating main body through a pivot pin, having a push part disposed at an end thereof and a poke part disposed at other end thereof, and under a condition that the poke part is poked to rotate, the push part is inserted into the sunken portion to abut with the other end of the blade and force the other end of the blade to bend and deform, to make the second engagement slot escape from a state of being engaged and located on the rear section of the engagement part, so as to enable the blade to be pulled out in a direction away from the handle.

2. The knife structure according to claim 1, wherein the sunken portion is provided with a second groove disposed thereon and correspondingly to a side of the push part, the second groove has a structure matching with the push part, to enable the push part to be inserted into the sunken portion.

3. The knife structure according to claim 2, wherein the push part is sheet-shaped and has a protruding part disposed at an end thereof, and under a condition that the push part is inserted into the second groove, the protruding part is exposed to the sunken portion through the second groove, so as to push the other end of the blade.

4. The knife structure according to claim 1, further comprising a recovering spring which has two corresponding ends connected to the poke element and the locating main body respectively, and wherein under a condition that the poke part is not poked, the push part is kept at a location away from the sunken portion subject to a resilient recovering force of the recovering spring.

5. The knife structure according to claim 2, further comprising a recovering spring which has two corresponding ends connected to the poke element and the locating main body respectively, and wherein under a condition that the poke part is not poked, the push part is kept at a location away from the sunken portion subject to a resilient recovering force of the recovering spring.

6. The knife structure according to claim 3, further comprising a recovering spring which has two corresponding ends connected to the poke element and the locating main body respectively, and wherein under a condition that the poke part is not poked, the push part is kept at a location away from the sunken portion subject to a resilient recovering force of the recovering spring.

7. The knife structure according to claim 4, wherein the other end of the locating main body is fastened in the handle.

8. The knife structure according to claim 5, wherein the other end of the locating main body is fastened in the handle.

9. The knife structure according to claim 6, wherein the other end of the locating main body is fastened in the handle.

10. The knife structure according to claim 4, wherein the other end of the locating main body is pivotally connected in the handle, and the handle defines a receiving space inside to enable the locating main body and the blade to be received in the receiving space or rotated out of the handle.

11. The knife structure according to claim 5, wherein the other end of the locating main body is pivotally connected in the handle, and the handle defines a receiving space inside to enable the locating main body and the blade to be received in the receiving space or rotated out of the handle.

12. The knife structure according to claim 6, wherein the other end of the locating main body is pivotally connected in the handle, and the handle defines a receiving space inside to enable the locating main body and the blade to be received in the receiving space or rotated out of the handle.

13. The knife structure according to claim 10, wherein the handle has an elastic stop plate disposed on an inside wall, the elastic stop plate has a fix end fastened at a location in the handle and away from the locating main body, and a free end movably extended into the receiving space and adjacent to the other end of the locating main body, and under a condition that the locating main body is completely rotated out of the handle, the free end of the elastic stop plate is abutted against the other end of the locating main body; and under a condition that the free end of the elastic stop plate is pressed towards the inside wall of the handle, the locating main body is allowed to rotate towards the receiving space to be received into the receiving space.

14. The knife structure according to claim 11, wherein the handle has an elastic stop plate disposed on an inside wall, the elastic stop plate has a fix end fastened at a location in the handle and away from the locating main body, and a free end movably extended into the receiving space and adjacent to the other end of the locating main body, and under a condition that the locating main body is completely rotated out of the handle, the free end of the elastic stop plate is abutted against the other end of the locating main body; and under a condition that the free end of the elastic stop plate is pressed towards the inside wall of the handle, the locating main body is allowed to rotate towards the receiving space to be received into the receiving space.

15. The knife structure according to claim 12, wherein the handle has an elastic stop plate disposed on an inside wall, the elastic stop plate has a fix end fastened at a location in the handle and away from the locating main body, and a free end movably extended into the receiving space and adjacent to the other end of the locating main body, and under a condition that the locating main body is completely rotated out of the handle, the free end of the elastic stop plate is abutted against the other end of the locating main body; and under a condition that the free end of the elastic stop plate is pressed towards the inside wall of the handle, the locating main body is allowed to rotate towards the receiving space to be received into the receiving space.

16. The knife structure according to claim 13, wherein the locating main body has an assembly groove disposed on a part of the other end thereof adjacent to the sunken portion, and the pivot pin is inserted through the assembly groove to locate the poke element in the assembly groove, to make the poke element rotatable about the pivot pin.

17. The knife structure according to claim 14, wherein the locating main body has an assembly groove disposed on a part of the other end thereof adjacent to the sunken portion, and the pivot pin is inserted through the assembly groove to locate the poke element in the assembly groove, to make the poke element rotatable about the pivot pin.

18. The knife structure according to claim 15, wherein the locating main body has an assembly groove disposed on a part of the other end thereof adjacent to the sunken portion, and the pivot pin is inserted through the assembly groove to locate the poke element in the assembly groove, to make the poke element rotatable about the pivot pin.
